(19) United States
(12) Patent Application Publication
(10) Pub. No.: US 2013/0091522 A1
(43) Pub. Date: Apr. 11, 2013

(54) METHOD TO DISPLAY ADDITIONAL INFORMATION ON SCREEN

(71) Applicants: Nobukazu Sugiyama, San Diego, CA (US); Klaus Hofrichter, San Diego, CA (US); Sriram Sampathkumaran, San Diego, CA (US)

(72) Inventors: Nobukazu Sugiyama, San Diego, CA (US); Klaus Hofrichter, San Diego, CA (US); Sriram Sampathkumaran, San Diego, CA (US)

(73) Assignee: SONY CORPORATION, A JAPANESE CORPORATION, Tokyo (JP)

(21) Appl. No.: 13/253,903

(22) Filed: Oct. 5, 2011

(51) Int. Cl. H04N 21/20

(52) U.S. Cl. 725/44

(57) ABSTRACT

The present invention is directed toward a system and method for simultaneously displaying one or more social media content items together with the display of programming content, such as a television show. Specifically, the present invention provides a system and method by which contemporary and/or time-shifted social media commentary, pertaining to broadcast programming content, may be displayed concurrently with the displayed programming content.

### FIELD OF THE INVENTION

The present invention pertains generally to a method and apparatus for displaying programming content together with viewer created social media content. More specifically, the instant invention relates to the simultaneous display of contemporaneous and/or time-shifted social media commentary together with programming content, such as network or cable television programming.

### BACKGROUND OF THE INVENTION

In recent years, internet access has become ubiquitous in consumer electronic devices including entertainment systems and television displays. During the same period, there has been explosive growth in the prevalence of social networking technologies as well as an increase in the roll of social media in the entertainment industry.

### SUMMARY OF THE INVENTION

Several embodiments of the invention advantageously address the emerging need to deliver social media content to internet ready entertainment systems, as well as other needs by providing a processor-based device comprising: a display electrically coupled to a processor; a network module, the network module electrically coupled to the processor and configured for communication with one or more computer and/or cable networks; a storage device electrically coupled to the processor, wherein the processor is configured to perform steps comprising: receiving programming content and content identification information; generating one or more context keywords based at least in part on the content identification information; searching for program-related content, wherein the searching is based at least in part on the one or more context keywords; retrieving at least a portion of the program-related content, wherein the portion of the program-related content is contextually related to the one or more context keywords; and displaying at least a portion of the retrieved program-related content and at least a portion of the programming content on the display.

In another embodiment, the invention comprises a computer program product comprising a tangible medium having one or more programs embodied thereon for causing the computer to perform steps of: receiving programming content and content identification information; generating one or more context keywords based at least in part on the content identification information; searching for program-related content, wherein the searching is based at least in part on the one or more context keywords; retrieving at least a portion of the program-related content, wherein the portion of the program-related content is contextually related to the one or more context keywords; and displaying at least a portion of the retrieved program-related content and at least a portion of the programming content.

### BRIEF DESCRIPTION OF THE DRAWINGS

The above and other exemplary aspects, features and advantages of certain exemplary embodiments of the present invention will be more apparent from the following detailed description taken in conjunction with the accompanying drawings, in which:

FIG. 1 is a block diagram illustrating a processor-based system 100 that may be used to run, implement and/or execute the methods and/or techniques shown and described herein in accordance one aspect of the invention;

FIG. 2 is a flow diagram of a method for retrieving program-related content for display with programming content in accordance with one aspect of the invention;

FIG. 3 is a flow diagram of a method for generating one or more context keywords and searching for program-related content based in accordance with one aspect of the invention; and

FIG. 4 illustrates a method of displaying time-shifted program related content together with programming content that has been stored or recorded according to one aspect of the invention.

Throughout the drawings, the same drawing reference numerals will be understood to refer to the same elements, features, and structures.

### DETAILED DESCRIPTION

Reference will now be made in detail to certain embodiments of the present disclosure, examples of which are illustrated in the accompanying figures. It is to be understood that the figures and descriptions of the present disclosure illustrate and describe elements that are of particular relevance to the present disclosure, while eliminating, for the sake of clarity, other elements found in typical personal computer and/or tablet PC systems. Accordingly, those of ordinary skill in the art will recognize that various changes and modifications of the embodiments described herein can be made without departing from the scope and spirit of the invention.

An exemplary embodiment of the present invention proposes a method for displaying social-media commentary on the display of an internet embedded television, concurrent with the display of programming content such as network television programming. For example, some aspects of the invention allow content viewers to search for and/or automatically receive social-media commentary related to the programming content that they are viewing. Further, some aspects of the instant invention enable a user to view time-shifted social commentary, such that the social commentary that is contemporary with the airing of programming content can be displayed concurrently with recorded or stored programming content.

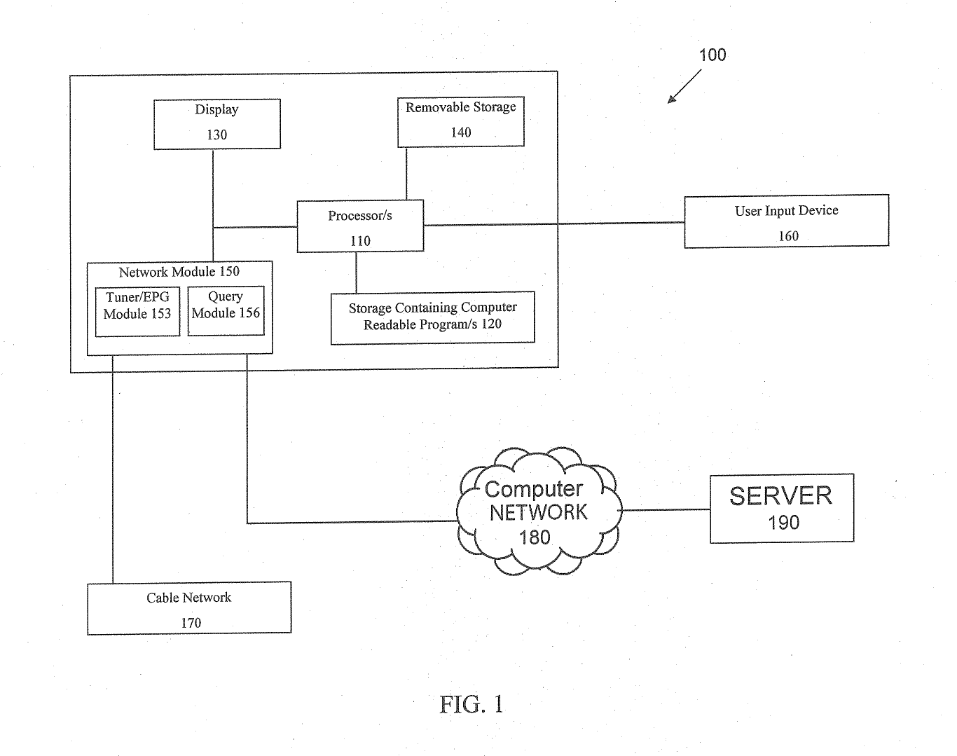

FIG. 1 illustrates a system 100 for concurrently displaying programming content and program-related content according to a first exemplary embodiment of the instant invention.

As shown in FIG. 1, the system 100 includes: one or more processor/s 110, a storage 120, a display 130, a removable storage 140, a network module 150 comprising a tuner/EPG module 153 and a query module 156, a user input device 160, a cable network 170, a computer network 180 (e.g., the internet) and a server 190. As would be appreciated by those of skill in the art, the system 100 may comprise essentially any processor-based computing device, including but not limited to one or more: internet enabled televisions (TVs), personal computers, console game systems, tablet PC devices, entertainment systems, mobile phones, PDAs, etc.

The storage device 120 may comprise essentially any type of tangible non-transitory memory device and may optionally include external memory and/or removable storage media such as a digital video disk (DVD), Blu-ray disc, compact disk (CD) and/or one or more magnetic or flash-based memory devices such as a USB storage device or other tangible non-transitory memory device, etc. By way of example, the storage device 120 may be used for storing software code that implements the methods and techniques described herein.

In some aspects of the invention, the network module 150 is configured to communicate with one or more other processor based devices via one or more computer networks and/or cable network systems (e.g., the computer network 180 and/or the cable network 170 of the system 100). As would be understood by those of ordinary skill in the art, the network module 150 may be configured to transmit and receive information using either wired, wireless and/or optical communications. Furthermore, the network module 150 may include one or more tuner or EPG modules and/or one or more query module/s 156, as will be discussed in further detail below.

In some aspects of the invention, the user input device 160 may comprise one or more television remote controls, wired or wireless game controllers and/or one or more wired or wireless keyboards, joysticks and/or computer mouse devices. However, as would be appreciated by one of ordinary skill in the art, the user input device 160 may comprise essentially any device user to provide information input to a processor based system such as the system 100.

As depicted in FIG. 1, in some aspects of the invention, the storage 120, the display 130, the removable storage 140, the network module 150 and the user input device 160, are electrically coupled to the processor 110. The network module 150 is further coupled to the cable network 170 and the computer network 180 (e.g., a local area network (LAN), ISP network or home network with internet access); as would be appreciated by one of ordinary skill in the art, the computer network 180 will be communicatively connected to one or more processor based devices such as one or more servers (e.g., the server 190 depicted in FIG. 1).

In operation the system 100 displays programming content together with program-related content that is contextually related to the programming content, on the display 130. As would be understood by one of skill in the art, programming content could comprise essentially any type of public broadcast or paid programming such as cable TV or satellite TV content. However, in some aspects of the invention, programming content may comprise information streamed via one or more computer networks, such as the internet.

Furthermore, program-related content may comprise virtually any information or commentary that is contextually related to the programming content. By way of example, program-related content may comprise information transmitted by one or more users of one or more social networks wherein the transmitted information pertains to at least a part of the programming content. By way of example, the program-related content may contain commentary regarding the programming content, posted by one or more users via a social network such as (but not limited to), Google+, Twitter or Facebook, etc.

In some aspects, the program-related content may comprise one or more advertisements. For example, program-related content may comprise targeted advertising that is relevant to a particular user and/or contextually related to one or more portions of the received programming content.

In operation, the system 100 receives programming content from the network module 150. In some aspects, the programming content may be received via the tuner/EPG module 153 of the network module 150. However, in some aspects of the invention, the programming content may be received, in whole or in part, from the computer network 180, such as the internet.

Furthermore, content-identification information may be received from the tuner/EPG module 153 of the network model 150 via the cable network 170 and may include electronic programming guide (EPG) data including, but not limited to: (1) electronic programming guide data, (2) closed captioning data, (3) region information and/or (4) channel information, etc. In some aspects of the invention, content identification information may be received from a user via one or more user input devices. By way of example, a user may provide content identification information in the form of one or more information inputs, e.g., by entering one or more keywords or search terms via the user input device 160 (e.g., a TV remote control, wireless keyboard, pointer device and/or game controller, etc.).

When content identification is received from e.g., from the user via the user input device 160 or the tuner/EPG module 153, a context keyword may be generated from the user input and/or based at least in part on one or more information items such as the (1) electronic programming guide data, (2) closed captioning data, (3) region information and/or (4) channel information, as mentioned above. The generated context keyword will typically identify at least a portion of the programming content that is being displayed on the display 130. By way of example, if a user is currently watching a TV show entitled “American Idol”, the name of the show “American Idol” may be retrieved from the cable network 170 and received by the system 100 via the tuner/EPG module 153.

Next, program related content pertaining to the programming content (e.g., social media information related to the displayed programming content) will be searched via the query module 156, using the generated context keyword. For example, if a user is currently watching American Idol, the query module 156 may search for the term “American Idol” using the computer network 180. However, as would be understood by those of skill in the art, essentially any context keyword identifying any portion of the displayed programming content may be used as a search term.

In some aspects, the search will occur on one or more servers, such as the server 190 and will return program-related content pertaining to the programming content being displayed on the display 130. By way of further example, the program-related content may be current social media commentary from one or more users originating from one or more social networks such as (but not limited to) Google+, Facebook, Twitter, Myspace, etc. In some aspects, the returned program-related content is then displayed on the display concurrently with the programming content. By way of example, the program-related content may be displayed above, below, or on either side of the programming content displayed on the display 130. In some aspects, the displayed program-related content may be displayed on top of (i.e., overlaid upon) the displayed programming content.

In one aspect of the invention, programming content may be recorded to one or more storage devices such as the storage 120 or the removable storage 140 of the system 100 and may be displayed with time-shifted program-related content. By way of example, at the time the programming content is stored, contemporary program-related content (e.g., social media commentary contemporary with the display of the programming content) may be displayed to one or more storage devices such as the storage 120 or the removable storage 140 of the system 100. When the programming content is displayed on the display 130, the stored program-related content may be retrieved and displayed with the programming content. Thus, when a user views stored programming content (i.e., one or more pre-recorded television shows), time-shifted social media commentary may be displayed upon the playback of the stored programming content.

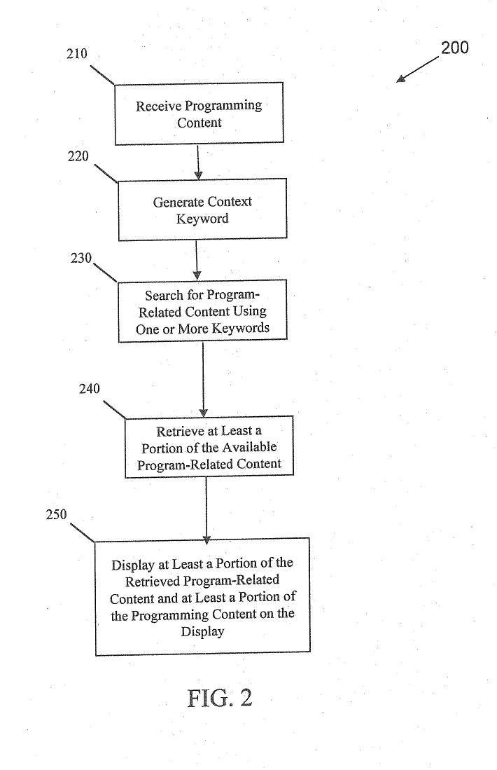

FIG. 2 depicts a method 200 for displaying programming content together with program-related content according to one aspect of the invention. The method 200 begins with step 210 in which programming content is received by the system (e.g., the system 100 of FIG. 1, above).

As would be understood by those of skill in the art, the programming content received in step 210 may be received via essentially any source, including but not limited to one or more: satellite/s, cable network/s, radio broadcast/s and/or internet connection/s, etc. In some aspects of the invention, the programming content may include or will be supplemented by content identification information. By way of example, content identification information may include one or more types of information that identify the programming content, such as, but not limited to: title information, EPG data, channel information, program duration, broadcast time, regional information, language information, etc. However, in some aspects of the invention, content identification information may be received from a user via one or more user input devices, such as the user input device 160 of the system 100, described above.

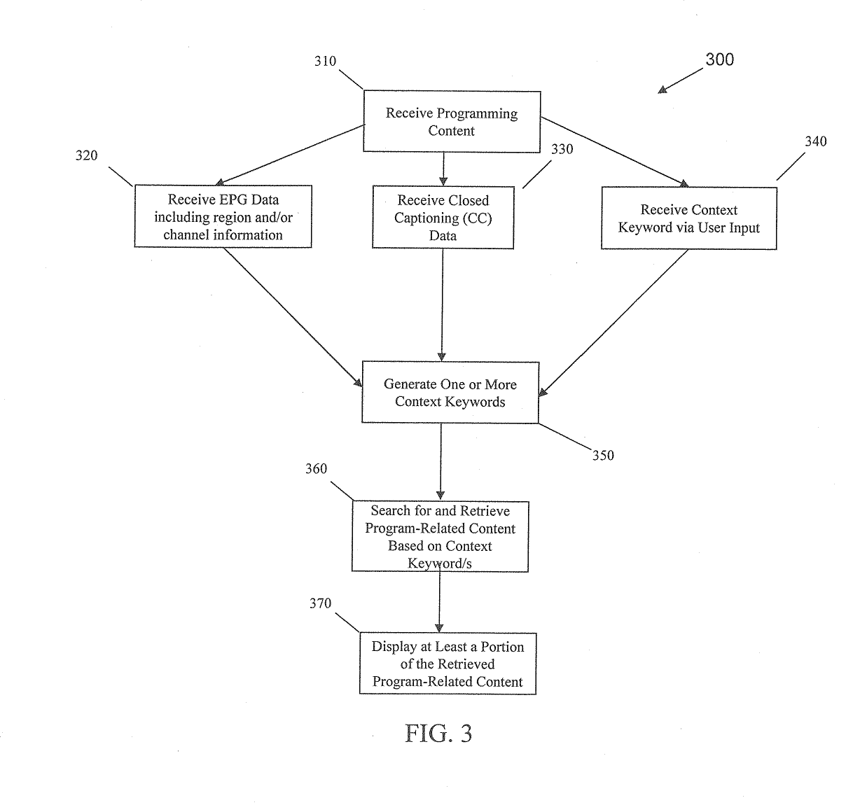

As illustrated in step 220 of the method 200, in some aspects of the invention, one or more context keywords will be generated based at least in part on the received content identification information. By way of example, the context keyword may comprise one or more search terms entered by a user (e.g., using the user input device 160 in the system 100). In some aspects, one or more context keywords may be generated based at least in part on content identification information received with the programming content (e.g., EPG data), as will be discussed in further detail with respect to FIG. 3, below.

In step 230, program-related content is searched for using one or more context keywords generated in step 220. As would be appreciated by those of skill in the art, searching for program related content may occur on one or more servers via a computer network such as the computer network 180 of the system 100. Furthermore, program-related content may comprise virtually any user created content; for example, program related content may comprise commentary authored by one or more social network users, regarding the subject matter of the programming content received in step 210, discussed above. In some aspects, the program-related content may comprise one or more advertisements. For example, the program-related content may contain one or more targeted advertisements relevant to past or presently received programming content and/or specific to the preferences or viewing habits of a particular user.

In step 240, at least a portion of the available program-related content is retrieved. As would be understood by those of skill in the art, upon searching for program-related content, perhaps only a portion of the available program-related content is retrieved by the system. For example, some program-related content may be retrieved in preference to other portions of the available program-related content on the basis of relevance to the programming content, temporal relationship to the broadcast of the programming content, etc. In some aspects, one or more filters may be invoked (e.g., parental control filters) in order to filter the retrieved program-related content. For example, program-related content may be filtered on the basis of language, location and/or subject matter content, etc.

In step 250, at least a portion of the program-related content retrieved in step 240 is simultaneously displayed with the programming content, e.g., on the display 130 of the system 100. As would be understood by those of skill in the art, the program-related content may be displayed in essentially any portion of the display concurrently with the programming content. For example, the program-related content may be displayed above, below or to either side of the displayed programming content. In some aspects of the invention, the program-related content may be displayed in a manner wherein the program-related content is overlaid upon (i.e., displayed over) the programming content.

FIG. 3 illustrates a method 300 for displaying programming content with at least a portion of retrieved program-related content, according to one aspect of the invention. The method 300 begins with step 310 in which programming content is received by a processor-based system (e.g., the system 100 of FIG. 1). Next, content identification information, identifying at least a portion of the programming content, is received from one or more sources.

As illustrated in step 320, in some aspects, content identification information is received in the form of electronic programming guide (EPG) data (e.g., via the tuner/EPG module 153 of the system 100). Typically, EPG data may comprise several types of information, including information related to the channel, region, broadcast time and/or broadcast duration of one or more items of programming content. In some aspects, EPG data may comprise information regarding the title, genre, language information and/or critic or user rating information, etc., pertaining to the programming content. Additionally, content identification information may include information related to the programming content such as the names of programming content contributors, e.g., actor names, directors and/or studio name/s, etc. As would be understood by those of skill in the art, essentially any type of information pertaining to the programming content may be included in the EPG data.

Furthermore, as illustrated by step 330, the content identification information may comprise additional data such as closed captioning information and/or as illustrated in step 340, the content identification may also comprise a keyword input by one or more users (e.g., using the user input device 160 of the system 100).

In step 350 one or more context keywords are generated from at least a portion of the content identification information received in any of steps 320, 330 and/or 340. In some aspects, one or more context keywords may be generated by simply parsing the information or terms received in steps 320-340. By way of example, the content identification information received in step 340 may comprise an input string entered by the user such as “best American Idol performances.” Thus, in step 350 the system may generate the search terms “American Idol” and/or “American Idol performances” and/or “best performances”, etc.

In some aspects, one or more context keywords may be generated through the concatenation of terms from the content identification information received in any of steps 320-340. Using the above example, if a user inputs the string “American Idol”, the generated context keyword may comprise a concatenation of the terms “American” and “Idol”, e.g., producing the strings: “AmericanIdol” and/or “Americanidol”, etc. As would be understood by those of skill in the art, content identification information may be parsed, concatenated and/or reformatted in order to generate one or more context keywords.

In step 360, program related content is searched for, and retrieved, based on the context keywords generated in step 350. In some aspects, the search will be initiated by one or more processor/s (e.g., the processor/s 110 of the system 100) using the query module 156.

In some aspects, the search will be conducted via a computer network (e.g., the computer network 180 of the system 100) and carried out on one or more servers such as the server 190 of the system 100.

In step 370, at least a portion of the program-related content retrieved in step 360 is simultaneously displayed with the programming content, e.g., on the display 130 of the system 100. In some aspects, the program-related content may be displayed in essentially any portion of the display concurrently with the programming content. For example, the program-related content may be displayed above, below or to either side of the displayed programming content. The program-related content may be displayed in a manner wherein the program-related content is overlaid upon (i.e., displayed over) the programming content.

Additionally, in some aspects of the invention, properties related to the display of the program-related content may be changed. For example, the user may change the location on the display where the program-related content is displayed. Furthermore, in some aspects the user may change the scroll speed of the displayed program-content and/or may disable the display of one or more portions of the displayed program-related content altogether.

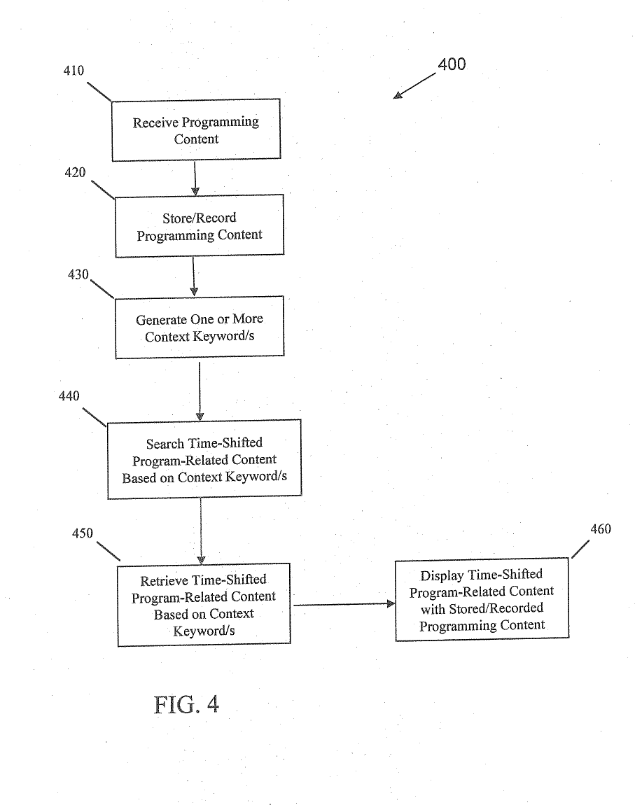

FIG. 4 illustrates a method 400 by which programming content and program-related content may be stored and then displayed such that the displayed programming content is contemporary with the program-related content being concurrently displayed. The method 400 begins with step 410 in which programming content is received by the system.

In step 420, at least a portion of the programming content is stored to a storage device, e.g., the storage 120 or the removable storage 140 depicted in the system 100 of FIG. 1. However, as would be understood by those of skill in the art, the programming content may be stored on essentially any memory device and in some aspects may be stored remotely, e.g., on one or more servers accessible via a computer such as the internet.

Proceeding to step 430, the system generates one or more context keywords, based at least in part on content identification information, to be used for searching program related content. As discussed above relative to step 350 of the method 300, one or more context keywords will be generated based at least in part on the received content identification information. By way of example, the context keyword may comprise one or more search terms entered by a user (e.g., using the user input device 160 in the system 100). In some aspects, one or more context keywords may be generated based at least in part on content identification information received with the programming content via the cable network 170 of the computer network 180, such as the internet.

In step 440, time-shifted program-related content will be searched based at least in part on the context keywords generated in step 430. Specifically, program-related content that is contemporary in time with the originally broadcast programming content will be searched. By way of example, if an original episode of American Idol were broadcast at a specific date and time and then recorded, program-related content contemporary with the broadcast date and time would be searched.

In some aspects of the invention, the search for program-related content may employ one or more filters, such as a geo filter that may be used to search for social media content which coincides with the airing of programming content at a defined time and/or time zone. For example, if an episode of American Idol airs at 9 PM EST and not until 9 PM PST, then a geo filter may be used to limit the search for program-related content (i.e., social media content related to the episode) to only content originating from the Pacific time zone, e.g., beginning at 9 PM.

In step 450 at least a portion of the available time-shifted program-related content will be retrieved. In some aspects of the invention, the retrieval of time-shifted program-related content may comprise a transfer to one or more storage devices of the system (e.g., the system 100 of FIG. 1). However, in some aspects of the invention retrieval of at least a portion of the time-shifted program-related content may comprise streaming the content to the system 100.

In step 460, the retrieved time-shifted program-related content will be displayed together with the programming content. Thus, by way of example, using the method 400, a user may record an original airing of an episode of American Idol and upon replaying the recorded episode, the user may simultaneously view social media commentary that was made at the time of the original airing.

As would be understood by those of skill in the art, the time-shifted program-related content may be displayed in any portion of the display simultaneously with the display of the programming content. Similar to those embodiments described above with respect to step 370 of the method 300, the time-shifted program-related content may be displayed above, below or to either side of the displayed programming content (e.g., on the display 130 of the system 100). Furthermore, the time-shifted program-related content may be displayed in a manner wherein the time-shifted program-related content is overlaid upon (i.e., displayed over) the programming content.

The present invention has been described above in terms of presently preferred embodiments so that an understanding of the present invention can be conveyed. There are, however, many configurations for the system not specifically described herein but with which the present invention is applicable. The present invention is therefore not limited to the particular embodiments described herein, but rather, it should be understood that the present invention has wide applicability with respect to networked entertainment systems generally. All modifications, variations, or equivalent arrangements and implementations that are within the scope of the attached claims should therefore be considered within the scope of the invention.

1. A processor-based system comprising:
a display electrically coupled to a processor;
a network module, the network module electrically coupled to the processor and configured for communication with one or more computer and/or cable networks;
a storage device electrically coupled to the processor, wherein the processor is configured to perform steps comprising:
receiving programming content and content identification information;
generating one or more context keywords based at least in part on the content identification information;
searching for program-related content, wherein the searching is based at least in part on the one or more context keywords;
retrieving at least a portion of the program-related content, wherein the portion of the program-related content is contextually related to the one or more context keywords; and
displaying at least a portion of the retrieved program-related content and at least a portion of the programming content on the display.

2. The system of claim 1, wherein the content identification information is received via the network module and comprises at least one of:
(1) electronic programming guide (EPG) data;
(2) closed captioning data;
(3) region information; or
(4) channel information.

3. The system of claim 1, wherein the retrieved program-related content and the portion of the programming content are displayed simultaneously; and
wherein the program-related content is continuously updated to correspond with the portion of the programming content being displayed.

4. The system of claim 1 further comprising:
an input device electrically coupled to the processor; and
wherein the content identification information comprises one or more context keywords that are based at least in part on information received from a user via the input device.

5. The system of claim 1, wherein the program-related content is received from one or more social-networking servers via the network module.

6. The system of claim 1, wherein the retrieved program-related content is at least in part content created by one or more social-network users.

7. The system of claim 1, wherein at least a portion of the programming content and at least a portion of the retrieved program-related content is simultaneously displayed on the display.

8. The system of claim 1, wherein at least a portion of the received programming content is stored to the storage device,
wherein the displaying at least a portion of the programming content comprises displaying at least a portion of the programming content stored to the storage device simultaneously with at least a portion of the retrieved program-related content; and
wherein the retrieved program-related content being displayed is contemporary in time with the stored programming content being displayed.

9. The system of claim 1, wherein the program-related content comprises information produced by one or more viewers of the programming content.

10. The system of claim 1, wherein the program-related content comprises advertising content.

11. A computer program product comprising a tangible medium having one or more programs embodied thereon for causing the computer to perform steps of:
receiving programming content and content identification information;
generating one or more context keywords based at least in part on the content identification information;
searching for program-related content, wherein the searching is based at least in part on the one or more context keywords;
retrieving at least a portion of the program-related content, wherein the portion of the program-related content is contextually related to the one or more context keywords; and
displaying at least a portion of the retrieved program-related content and at least a portion of the programming content.

12. The program product of claim 11, wherein the content identification information comprises at least one of:
(1) electronic programming guide (EPG) data;
(2) closed captioning data;
(3) region information; or
(4) channel information; and
wherein the one or more context keywords are generated, at least in part, based on the content identification information.

13. The program product of claim 11, wherein the retrieved program-related content and the portion of the programming content are displayed simultaneously; and
wherein the program-related content is continuously updated to correspond with the portion of the programming content being displayed.

14. The program product of claim 11, wherein the one or more context keywords are based at least in part on information received from a user.

15. The program product of claim 11, wherein the retrieved program-related content is received via one or more social-networking servers.

16. The program product of claim 11, wherein the retrieved program-related content is at least in part content created by one or more social-network users.

17. The program product of claim 11, wherein at least a portion of the programming content and at least a portion of the retrieved program-related content is simultaneously displayed on a display.

18. The program product of claim 17, wherein the programming content is contemporary in time with the retrieved program-related content.

19. The program product of claim 11, wherein the retrieved program-related content comprises content produced by one or more viewers of the programming content.

20. The program product of claim 11, wherein the retrieved program-related content comprises advertising that is contextually related to the programming content.
